(19) United States
(12) Patent Application Publication
(10) Pub. No.: US 2024/0220864 A1
(43) Pub. Date: Jul. 4, 2024

(54) METHOD, APPARATUS, DEVICE, AND MEDIUM FOR PROCESSING VISUAL TASK BY GENERIC MODEL

(71) Applicant: Beijing Youzhuju Network Technology Co., Ltd., Beijing (CN)

(72) Inventors: Yi Jiang, Beijing (CN); Bin Yan, Beijing (CN); Jiannan Wu, Beijing (CN); Zehuan Yuan, Beijing (CN)

(21) Appl. No.: 18/531,091

(22) Filed: Dec. 6, 2023

(30) Foreign Application Priority Data
Dec. 28, 2022 (CN) 2022117007534

(51) Int. Cl. G06N 20/00

(52) U.S. Cl. CPC G06N 20/00

(57) ABSTRACT

A method, apparatus, device, and medium are provided for processing a visual task by a generic model. In a method, visual data and prompt data associated with a visual task are received, the visual task specifying that a processing result associated with the prompt data is to be determined from the visual data. A generic prompt representation of the prompt data is obtained, the prompt data including either an image format or a language expression format. A generic visual representation of the visual data is obtained, the visual data including either an image format or a video format. The processing result is determined based on the generic prompt representation and the generic visual representation. Here, different visual tasks can be processed in a unified way, training data can be shared across a plurality of visual tasks, and the processing performance of the generic processing model can be improved.

### CROSS-REFERENCE TO RELATED APPLICATIONS

The present application claims priority to Chinese Patent Application No. 202211700753.4 filed on Dec. 28, 2022, and entitled “METHOD, APPARATUS, DEVICE, AND MEDIUM FOR PROCESSING VISUAL TASK BY GENERIC MODEL”, the entirety of which is incorporated herein by reference.

### FIELD

Example implementations of the present disclosure generally relate to visual task processing, and in particular, to a method, apparatus, device, and computer readable storage medium for processing a visual task by a generic processing model.

### BACKGROUND

Machine learning technology has been widely used to process visual tasks related to instance perception. In order to improve the processing performance of visual tasks, visual tasks are usually subdivided into a large number of branches, such as object detection, object segmentation, object tracking, and so on. Although refining tasks brings convenience for developing specific applications, too diverse task definitions make it difficult for models, which are designed independently for specific tasks, to learn generic knowledge across tasks and domains. At this time, how to train machine learning models in a more effective way to improve the processing performance of various visual tasks has become a difficult and hot topic in the field of visual processing.

### SUMMARY

In a first aspect of the present disclosure, a method of processing a visual task by a generic processing model is provided. In the method, visual data and prompt data associated with a visual task are received, the visual task specifying that a processing result associated with the prompt data is to be determined from the visual data. A generic prompt representation of the prompt data is obtained, the prompt data including either an image format or a language expression format. A generic visual representation of the visual data is obtained, the visual data including either an image format or a video format. The processing result is determined based on the generic prompt representation and the generic visual representation.

In a second aspect of the present disclosure, an apparatus for processing a visual task by a generic processing model is provided. The apparatus comprises: a receiving module, configured for receiving visual data and prompt data associated with the visual task, the visual task specifying that a processing result associated with the prompt data is to be determined from the visual data: a first obtaining module, configured for obtaining a generic prompt representation of the prompt data, the prompt data including either an image format or a language expression format: a second obtaining module, configured for obtaining a generic visual representation of the visual data, the visual data including either an image format or a video format: and a determination module, configured for determining the processing result based on the generic prompt representation and the generic visual representation.

In a third aspect of the present disclosure, an electronic device is provided. The electronic device comprises: at least one processing unit: and at least one memory, coupled to the at least one processing unit and storing instructions for execution by the at least one processing unit. The instructions, when executed by the at least one processing unit, cause the electronic device to perform a method according to the first aspect of the present disclosure.

In a fourth aspect of the present disclosure, a computer-readable storage medium is provided, on which a computer program is stored. The computer program, when executed by a processor, causes the processor to perform a method according to the first aspect of the present disclosure.

It would be understood that the content described in the Summary section of the present disclosure is neither intended to identify key or essential features of implementations of the present disclosure, nor is it intended to limit the scope of the present disclosure. Other features of the present disclosure will be readily envisaged through the following description.

### BRIEF DESCRIPTION OF THE DRAWINGS

Through the detailed description with reference to the accompanying drawings, the above and other features, advantages, and aspects of respective implementations of the present disclosure will become more apparent. The same or similar reference numerals represent the same or similar elements throughout the figures, wherein:

FIG. 1 shows a block diagram of categories of visual tasks according to an example implementation of the present disclosure:

FIG. 2 shows a block diagram of processing a visual task by a generic processing model according to some implementations of the present disclosure:

FIG. 3 shows a block diagram of visual data and prompt data associated with different visual tasks according to some implementations of the present disclosure:

FIG. 4 shows a block diagram of the structure of a generic processing model according to some implementations of the present disclosure:

FIG. 5 shows a block diagram of extracting a generic prompt representation according to some implementations of the present disclosure:

FIG. 6 shows a block diagram of the process of performing a plurality of visual tasks according to some implementations of the present disclosure:

FIG. 7 shows a flowchart of a method of processing a visual task by a generic processing model according to some implementations of the present disclosure:

FIG. 8 shows a block diagram of an apparatus for processing a visual task by a generic processing model according to some implementations of the present disclosure: and

FIG. 9 shows a block diagram of a device that can implement a plurality of implementations of the present disclosure.

### DETAILED DESCRIPTION

Implementations of the present disclosure will be described in more detail below with reference to the accompanying drawings. Although some implementations of the present disclosure are shown in the drawings, it would be understood that the present disclosure can be implemented in various forms and should not be interpreted as limited to the implementations described herein. On the contrary, these implementations are provided for a more thorough and complete understanding of the present disclosure. It would be understood that the drawings and implementations of the present disclosure are only for the purpose of illustration and are not intended to limit the scope of protection of the present disclosure.

In the description of implementations of the present disclosure, the term “comprising”, and similar terms should be understood as open inclusion, i.e., “comprising but not limited to”. The term “based on” should be understood as “at least partially based on”. The term “one implementation” or “the implementation” should be understood as “at least one implementation”. The term “some implementations” should be understood as “at least some implementations”. Other explicit and implicit definitions may also be comprised below:

It is understandable that the data involved in this technical proposal (comprising but not limited to the data itself, data obtaining, use, storage, or deletion) shall comply with the requirements of corresponding laws, regulations, and relevant provisions.

It is understandable that before using the technical solution disclosed in respective implementations of the present disclosure, users shall be informed of the type, using scope, and using scenario of personal information involved in the present disclosure in an appropriate way, and be authorized by users according to relevant laws and regulations.

For example, in response to receiving a proactive request from a user, prompt information is sent to the user to explicitly remind the user that a requested operation will require the obtaining and use of personal information of the user, so that the user may independently choose, according to the prompt information, whether to provide personal information to electronic devices, applications, servers or storage media and other software or hardware that perform operations of the technical solution of the present disclosure.

As an optional but non-limiting implementation, in response to receiving a proactive request from a user, the way of sending prompt information to the user may be, for example, a popup window; in which the prompt information may be presented in the form of text. In addition, the popup window may further carry a selection control for the user to choose “agree” or “disagree” to provide personal information to electronic devices.

It is understandable that the above process of notifying and obtaining user authorization is only for the purpose of illustration and does not imply any implementations of the present disclosure. Other ways, to satisfy the requirements of relevant laws and regulations, may also be applied to implementations of the present disclosure.

As used herein, the term “in response to” is to represent a state in which a corresponding event occurs or a condition is satisfied. It will be understood that the timing of the subsequent action performed in response to the event or a condition may not be strongly correlated with the time when the event occurs or the condition is satisfied. For example, in some cases, the subsequent action may be performed immediately when the event occurs or the condition is satisfied: in other cases, the subsequent action may be performed after a period after the event occurs or the condition is satisfied.

### Example Environment

Instance perception is one of the fundamental tasks of computer vision, which has many downstream applications in autonomous driving, intelligent surveillance, content understanding, etc. In the context of this disclosure, visual data can include image data and video data, and objects can represent entities with tangible shapes in visual data, including but not limited to persons, animals, objects, etc. For example, in an automatic driving environment, various vehicles in the road environment can be identified and tracked: in an intelligent surveillance system, various products in the production process can be identified and tracked, and so on.

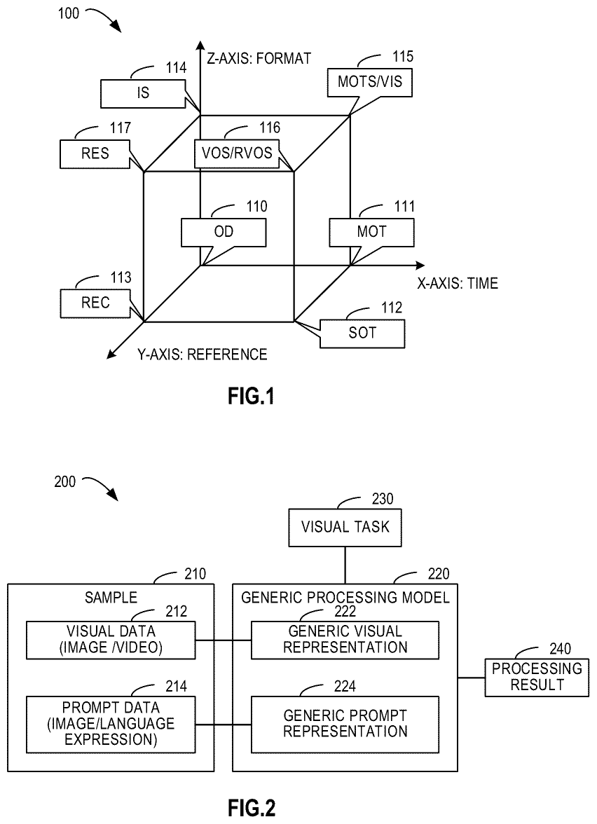

Instance perception tasks aim at finding specific objects specified by some queries. Here, queries can include, for example, category names, language expressions, and target annotations. Refer to FIG. 1 for an overview of visual tasks, which shows a block diagram 100 of the category of visual tasks according to an example implementation of the present disclosure. As shown in FIG. 1, visual tasks can involve a plurality of tasks, e.g., mainly involving 10 tasks each of which is distributed on the vertex of the cube shown in FIG. 1. As shown in FIG. 1, the x-axis of the coordinate system represents time, that is, whether visual data includes image data collected at different time points. In the direction indicated by the x-axis, visual data can change from single-frame image data to video data. The y-axis represents reference, that is, whether the visual task specifies the recognition of objects specified by prompts from visual data. In the direction of the z-axis, visual tasks can change from no prompts to including prompts according to language expression or image annotation format. The z-axis represents format, that is, the format of the recognized object. In the low-to-high direction of the format accuracy indicated by the z-axis, the format can change from a bounding box to a mask.

Specifically, as shown in FIG. 1, starting from Object Detection (OD) 110 at the origin of the coordinate axis and moving along the format axis z, coarse-grained bounding boxes of Object Detection 110 can change into fine masks for Instance Segmentation (IS) 114. Moving along the time axis x, visual data can change from static image data to dynamic video data. At this time, there may exist Multiple Object Tracking (MOT) 111, Multi-Object Tracking and Segmentation (MOTS), and Video Instance Segmentation (VIS) 115. Moving along the reference axis y, referring to language expressions or bounding boxes/masks and other reference information given in the previous video frame, there may exist three language-guided tasks: Reference Expression Comprehension (REC) 113, Reference Expression Segmentation (RES) 117, and Referring Video Object Segmentation (R-VOS), as well as two annotation-guided tasks: Single Object Tracking (SOT) 112 and Video Object Segmentation (VOS) 116.

Generally speaking, task processing models can be developed separately for refined tasks. Although refining tasks brings convenience for developing specific applications, too diverse task definitions split the whole instance perception filed into a large number of fragmented pieces. Currently, most instance perception technical solutions are only applicable to one or more specific task branches and trained on sample data from specific task branches. At this time, models independently designed for specific tasks can hardly learn and share generic knowledge between different tasks and domains, so that redundant parameters are caused and mutual collaboration between different tasks might be overlooked. For example, object detection data enables models to recognize common objects, which in turn can improve the performance of REC and RES. Furthermore, restricted by fixed-size classifiers, traditional object detection models are hard to perform jointly train on multiple datasets with different label vocabularies and to dynamically change object categories expected to be detected during inference.

At this time, how to train machine learning models in a more effective way and make machine learning models process various types of visual tasks with higher performance has become a difficult and hot topic in the field of visual processing.

### Overview of Visual Task Processing

In order to at least partly solve the draw backs of the prior art, a method for processing a visual task with a generic processing model is proposed according to an example implementation of the present disclosure. Refer to FIG. 2 for an overview according to an example implementation of the present disclosure, which shows a block diagram 200 for processing a visual task with a generic processing model according to some implementations of the present disclosure. According to an example implementation of the present disclosure, specific types of visual tasks are not distinguished, but a generic processing model 220 is developed for various types of visual tasks 230. According to an example implementation of the present disclosure, the visual task 230 can be any visual task described above, including but not limited to: object detection, instance segmentation, multi-object tracking, multi-object tracking and segmentation, video instance segmentation, referring expression compression, referring expression segmentation, referring video object segmentation, single object tracking, video object segmentation, and the like.

As shown in FIG. 2, a sample 210 associated with the visual task 230 may be received, which may include visual data 212 and prompt data 214. Here, the visual task 230 may describe the determining of a processing result 240 associated with the prompt data 214 from the visual data 212. Further, a generic prompt representation 224 of the prompt data 214 may be obtained, where the prompt data 214 includes either an image format or a language expression format. A generic visual representation 222 of the visual data 212 may be obtained, where the visual data 212 may include either an image format or a video format. Further, the processing result 240 may be determined based on the generic prompt representation 224 and the generic visual representation 222.

In the context of this disclosure, representations refer to features extracted for a certain entity, which can be implemented based on embeddings. Specifically, the visual representation can be a feature extracted for the visual data 212, and the prompt representation can be a feature extracted for the prompt data 214. Here, the generic processing model 220 can provide a generic instance perception technical solution. Generally speaking, various instance perception tasks aim at finding specific objects according to some queries. Here, the generic processing model 220 can provide a generic instance perception technical solution, and the generic instance perception model can be applied to specific downstream tasks.

According to an example implementation of the present disclosure, a UNIversal INstance perception model of the NEXT generation (UNINEXT) technical solution is proposed, and the generic processing model 220 can be implemented based on this technical solution. UNINEXT can reformulate different instance perception tasks into a unified instance perception paradigm, and can flexibly perceive instances of different types of objects by simply changing the input prompts.

With the example implementations of the present disclosure, a large amount of data for different tasks can be exploited for jointly training the generic processing model 220, which is particularly beneficial for tasks lacking training data. Furthermore, a unified instance representation model can provide higher performance and reduce redundant computation when handling multiple tasks simultaneously. The generic processing model can be used to perform multiple independent tasks (such as classical image-level tasks (object detection and instance segmentation), vision-and-language tasks (referring expression compression and segmentation), and video-level object tracking tasks, etc.), and higher accuracy is obtained.

### Detailed Process for Processing Visual Tasks

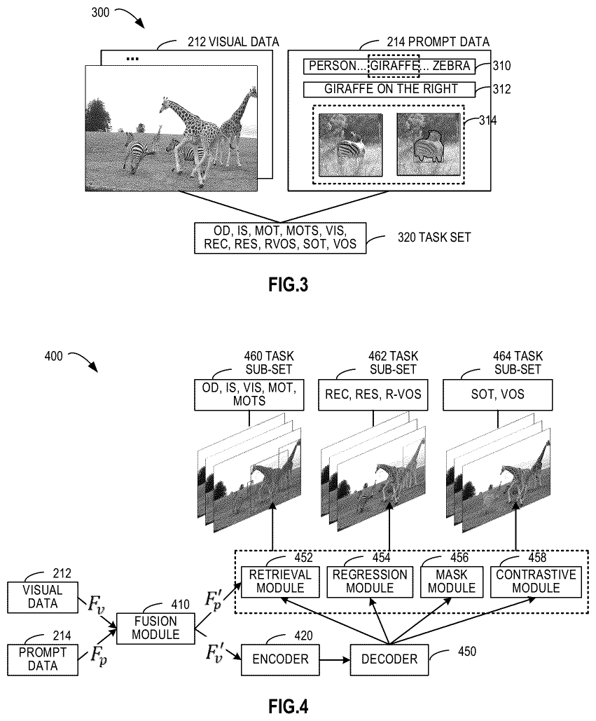

FIG. 3 illustrates a block diagram 300 of visual data and prompt data associated with different visual tasks in accordance with some implementations of the present disclosure. As shown in FIG. 3, the visual data 212 may include an image format, at which point each visual data 212 may include a single image frame. Alternatively and/or additionally, the visual data 212 may include a video format, at which point each visual data 212 may include a plurality of video frames in a video sequence.

According to an example implementation of the present disclosure, the prompt data 214 may include a variety of formats, such as either an image format or a language expression format. Specifically, the language expression format may further include a format based on the category name and a format described in language expression. A prompt 310 relates to a format based on the category name, and a prompt 312 relates to a format described in the language expression. Further, a prompt 314 represents a prompt based on the image format, and the annotations in the image indicate that it is desirable to recognize the object “zebra.” Further, a task set 320 of the visual task 230 can be divided into three types according to different prompts: (1) tasks that take category names as prompts (object detection, instance segmentation, VIS, MOT, MOTS): (2) tasks that take language expressions as prompts (REC, RES, R-VOS); and (3) tasks that take reference annotations as prompts (SOT, VOS).

With the example implementation of the present disclosure, different instances can be flexibly perceived by simply changing the input prompts, thereby implementing corresponding visual tasks 230. In order to handle different prompt modes, the generic processing model 220 may include a prompt encoder, which may consist of a reference text encoder and a reference visual encoder so as to process language expression format prompts and image format prompts respectively. Further, the generic processing model 220 may include a visual encoder for extracting representations of visual data. A fusion module can then be used to enhance the raw visual features of the current image and the prompt features. In this way, deep information exchange can be achieved and highly discriminative representations can be provided for the subsequent instance prediction step.

More details of the generic processing model 220 are described with reference to FIG. 4, which shows a block diagram 400 of the structure of a generic processing model according to some implementations of the present disclosure. As shown in FIG. 4, the visual data 212 and the prompt data 214 may be received. A generic visual representation 222 (e.g., represented by the symbol F) of the visual data 212 may be determined using an image-based encoder that is currently known and/or to be developed in the future. Further, a generic prompt representation 224 of the prompt data 214 may be determined using a prompt encoder (e.g., represented by the symbol Fₚ).

According to an example implementation of the present disclosure, during obtaining the generic prompt representation, the generic prompt representation can be extracted based on the format of the prompt data. Here, the generic processing model 220 is a generic model set for a variety of visual tasks 230, and the prompt data 214 can include various formats. Generating the corresponding generic prompt representation 224 according to the specific format of the prompt data 214 can determine the various features of the prompt data 214 in a more accurate way, thereby improving the accuracy of visual task post-processing.

Here, the prompt encoder can transform the original multi-modality (image-related prompts and language-related prompts) prompts into a unified form. Specifically, if it is determined that the format of the prompt data 214 is a language expression format, the language expression encoder can be used to extract the prompt representation 224. To process language-related prompts, language encoders (e.g., Enc_{L} encoders) that are currently known and/or will be developed in the future can be used.

Specifically, for tasks that take category names as prompts, the category names that appear in the current dataset can be concatenated as language expressions. Take the COCO dataset as an example. Assuming that the dataset involves category names such as person, bicycle, . . . , and toothbrush, the various category names in the dataset can be concatenated, and the language expression can be represented as “person, bicycle, . . . , toothbrush”. For the dataset including animal images, the language expression “person, . . . , giraffe, . . . , zebra” can be formed as shown by a prompt 310 in FIG. 3. Subsequently, the above language expressions can be input to the language encoder Enc_{L} to obtain a prompt embedding Fₚ∈ [symbol] ^{L×d}. Here, the length and width of the sequence are represented as L and d respectively, and the corresponding generic prompt representation 224 is obtained. For language expression format prompts (e.g., a prompt 312 in FIG. 3), the language expression can be directly input to the language encoder Enc_{L}.

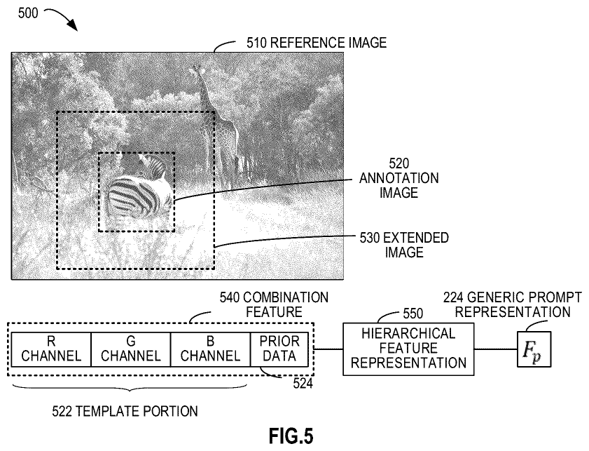

According to an example implementation of the present disclosure, if it is determined that the format of the prompt data 214 is an image format, a generic prompt representation 224 is extracted based on an extended image including an annotation image specified by the prompt data. In this way, the features of the image as a prompt can be more accurately determined, thereby improving the post-processing performance. Refer to FIG. 5 for more details of processing the prompt data 214 in the image format, which shows a block diagram 500 for extracting generic prompt representations according to some implementations of the present disclosure.

According to an example implementation of the present disclosure, in order to extract fine-grained visual features and fully exploit annotations, an additional reference visual encoder Enc_{V}^{ref} may be used. As shown in FIG. 5, an annotation image 520 may be determined in a reference image 510 based on prompts, and further, an area of a predetermined range (e.g., integer times the annotation image) around the annotation image 520 may be selected as an extended image 530. For example, the extended image 530 with 22 times (or other times) the annotation image 520 may be cropped centered on the annotation image 520 in the reference image. The extended image 530 may be used as a template and a generic prompt representation 224 may be determined. According to an example implementation of the present disclosure, the extended image 530 may be adjusted to a fixed size of 256×256 (or other sizes).

Specifically, based on a plurality of pixel data in the extended image 530, a first representation associated with the prompt data (e.g., template portion 522 in FIG. 5) can be determined. In order to introduce more precise target information, additional channels (referred to as the target priors) can be added to the extended image to form a 4-channel combination feature 540. Here, the prior value of the pixel data can indicate whether the pixel data belongs to the annotation image. Specifically, the prior values of the pixels in the annotation image 520 are 1 and the prior values of other pixels can be set to 0. Alternatively and/or additionally, the prior data can be set based on other methods. A second representation (e.g., prior data 524) associated with the prompt data can be determined based on the prior values of the plurality of pixel data in the extended image 530. Furthermore, a concatenation operation can be performed on the target portion 522 and the prior data 524, and the extended image 530 can be expanded from three channels to four channels. At this time, a four-channel combination feature 540 can be obtained.

Subsequently, the combination feature 540 can be input to the reference visual encoder Enc_{V}^{ref} to obtain a hierarchical feature representation 550. Here, the hierarchical feature representation 550 can be represented as a hierarchical feature pyramid {C3, C4, C5, C6}, and the dimensions of features of each level can be 32×32, 16×16, 8×8, and 4×4, respectively. Furthermore, in order to maintain fine annotation information and obtain the prompt embedding in the same format as other tasks, a merge operation can be performed. In other words, all levels features are first transformed to 32×32 (or other dimensions), then added and flattened as the final prompt embedding Fₚ∈ [symbol] ^{1024×d}.

According to an example implementation of the present disclosure, the prompt embedding can be generated based on the following Formula 1:

$${F}_{p} = \{ \begin{matrix}{Enc}_{L}^{ref} ( expression ) & prompt by expression - guided \\ {Enc}_{L}^{ref} ( concat ( categories ) ) & prompt by category - guided \\ merge ( {Enc}_{V}^{ref} ( [ template , prior ] ) & prompt by annotation - guided\end{matrix} \qquad Formula 1$$

In Formula 1, Fₚ denotes a generic prompt representation, Enc_{L}^{ref} denotes a language encoder, Enc_{V}^{ref} denotes a visual encoder, expression denotes a language expression in the prompt data, categories denotes a category name in the prompt data, cancat denotes a concatenation operation, template denotes a template part, prior denotes a prior part, and merge denotes a merge operation. With the example implementation of the present disclosure, different formats of the prompt data 214 can be processed separately, and the generic prompt representation 224 that can represent various features of multiple data formats can be obtained.

Returning to FIG. 4, further processing for the generic prompt representation 224 and the generic visual representation 222 is described. According to an example implementation of the present disclosure, a fusion module 410 may be used to enhance the original prompt embedding by the image contexts and to make the original visual embeddings prompt-aware. Specifically, the fusion module 410 may be based on bidirectional attention operations, thereby enabling the generic representation to consider the correlation between the generic visual representation 222 and the generic prompt representation 224. That is, attention operations may be performed for the generic prompt representation 224 and the generic visual representation 222 to obtain an updated generic prompt representation and an updated generic visual representation, respectively.

Specifically, a bidirectional attention operation may be performed on the generic prompt representation 224 and the generic visual representation 222, and then the generic prompt representation 224 and the generic visual representation 222 may be updated respectively using the results of the bidirectional attention operation. In this way, an updated generic prompt representation F′ₚ and an updated generic visual representation F′ᵥ may be obtained.

A bidirectional cross-attention module (Bi-XAtt) can be used to retrieve information from different inputs, and then the retrieved information can be added to the original embeddings. Along the first direction from the visual data to the prompt data, attention operations can be performed on the generic prompt representation and the generic visual representation to determine the embedding Fᵥ₂ₚ (for example, referred to as a first attention representation) between the generic prompt representation and the generic visual representation, and the embedding Fᵥ₂ₚ can further be used to update the generic prompt representation. In this way, the generic prompt representation 224 can be enhanced by the image contexts.

According to an example implementation of the present disclosure, along the second direction from the prompt data to the visual data, attention operations can be performed on the generic prompt representation and the generic visual representation in order to determine the embedding Fₚ₂ᵥ (e.g., referred to as a second attention representation) between the generic prompt representation and the generic visual representation, and Fₚ₂ᵥ can further be used to update the generic visual representation. In this way, the original visual embedding can have the function of prompt perception. Specifically, the updated prompt embedding and visual embedding can be determined based on the following Formula 2.

$${P}_{p 2 v} , {F}_{v 2 p} = Bi - XAtt ( {F}_{v} , {F}_{o} ) \qquad Formula 2$$

$${F}_{v}^{′} = {F}_{v} + {F}_{p 2 v} ; {F}_{p}^{′} = {F}_{p} + {F}_{v 2 p}$$

In Formula 2, Fₚ represents the original prompt embedding, Fᵥ represents the original visual embedding, Fₚ₂ᵥ represents the attention embedding in the prompt-visual direction, Fᵥ₂ₚ represents the attention embedding in the visual-prompt direction, F′ᵥ represents the generic visual embedding updated based on attention operations, and F′ₚ represents the generic prompt embedding updated based on attention operations. Through the bidirectional cross-attention module, the expressive force of prompt embedding and visual embedding can be improved.

Now that description has been presented above to the determining of the updated generic prompt representation F′ₚ and the updated generic visual representation F′ᵥ, these updated representations can be used to determine the result of an instance perception task. According to an example implementation of the present disclosure, the updated generic prompt representation F′ₚ and the updated generic visual representation F′ᵥ can be used to obtain the processing result. Specifically, a transformer-based encoder 420 and decoder 450 architecture can be used to determine the processing results with F′ₚ and F′ᵥ.

Specifically, a plurality of candidate query results corresponding to the prompt data can be queried in the visual data based on the updated generic prompt representation and the updated generic visual representation. In order to provide a more flexible instance query method, an object detector can be used as an instance decoder. At this time, N instance proposals can be obtained, and then matching instances can be retrieved from these proposals based on prompts. This flexible retrieval mechanism can overcome the shortcomings of traditional fixed-size classifiers and can jointly train data from different tasks and fields.

Furthermore, based on the plurality of candidate query results and weights associated with the prompt data, the scores of the plurality of candidate query results can be determined separately, and then the processing result can be determined based on the scores of the plurality of candidate query results. Here, the score can represent the degree of match between the candidate query result and the prompt data. In other words, the candidate query result that best matches the prompt data can be selected based on the score as the final processing result of the visual task.

According to an example implementation of the present disclosure, an encoder-decoder architecture based on a detection transformer (abbreviated as DETR) can be used to achieve more flexible instance queries. Here, the encoder can use hierarchical prompt-aware visual features as the inputs. With the help of multi-scale deformable self-attention, target information from different scales can be fully exchanged, bringing stronger instance features for the subsequent instance decoding. In addition, an auxiliary prediction head can be appended at the end of the encoder, generating N initial reference points with the highest scores as the inputs to the decoder.

The decoder takes the enhanced multi-scale features, N reference points from the encoder, as well as N object queries as the inputs. According to an example implementation of the present disclosure, object queries play a critical role in instance perception tasks. Two query generation strategies can be adopted: (1) static queries, which do not change with images or prompts: (2) dynamic queries, which are conditioned on the prompts. Static queries can be implemented based on the currently developed nn. Embedding( ) function. Dynamic queries can be performed by first pooling the enhanced F′ᵥ along the sequence dimension, obtaining a global representation, then repeating it by N times.

According to an example implementation of the present disclosure, static queries usually perform better than dynamic queries. The potential reason could be that static queries contain richer information and possess better training stability than dynamic queries. With the help of the deformable attention, a retrieval module 452 can effectively retrieve prompt-aware visual features and learn strong instance embedding Fᵢₙₛ∈ [symbol] ^{N×d}.

At the end of the decoder, a group of prediction modules can be used to obtain the final instance prediction. Specifically, a dynamic convolution-based regression module 454 and mask module 456 can generate target bounding boxes and masks respectively. In addition, a comparison module 458 is introduced to associate the current detection result with the previous trajectory in MOT, MOTS, and VIS based on contrastive learning. According to an example implementation of the present disclosure, N potential instance proposals can be mined.

According to an example implementation of the present disclosure, different types of prompt data can be processed in different ways to obtain corresponding weight matrices. In this way, it is possible for the weight matrix to describe factors expected to be noticed in the prompt data in a more accurate way, thereby improving the accuracy of determining the degree of match between the candidate queries and the prompts. Specifically, if it is determined that the prompt data is a category name defined according to the language expression format, the weight is determined based on the updated generic prompt representation. Alternatively and/or additionally, if it is determined that the prompt data is any of the description defined according to the language expression format and the image format, the weight is determined based on the global average pooling (GAP) of the updated prompt representation.

It will be understood that not all proposals correspond to the prompts. Therefore, truly matched object instances may be retrieved from these proposals by using the prompt embeddings. Specifically, given by prompt embeddings F′ₚ, for tasks that take categories as prompts, the embedding of each category name can be used as a weight matrix W∈ [symbol] ^{1×d}. In addition, for tasks that take expressions as prompts and annotations as prompts, a weight matrix may be obtained by aggregating the prompt embedding F′ₚ using global average pooling (GAP) along the sequence dimension, as shown in Formula 3 below:

$$W = \{ \begin{matrix}{F}_{p}^{′} [ i ] , i ∈ \{ 0 , 1 , … , C - 1 \} & prompt by category name \\ GAP ( {F}_{p}^{′} ) & prompt by expression / annotation\end{matrix} \qquad Formula 3$$

Finally, the instance-prompt matching score S can be calculated based on the matrix multiplication of the target features and the transposed weight matrix, S=FᵢₙₛW^{T}. Here, the matching score can be supervised by Focal Loss. Unlike fixed-size classifiers in existing technical solutions, the retrieval module here can select objects by the prompt-instance matching mechanism. This flexible design enables UNINEXT to be jointly trained on enormous datasets with diverse label vocabularies from different tasks and then learn generic instance representations.

The architecture of the generic processing model has been described. According to an example implementation of the present disclosure, the generic processing model can be gradually trained in multiple different stages. For example, the training process may consist of three stages: (1) generic perception pre-training (2) image-level joint training (3) video-level joint training. In this way, different training stages causes the generic processing model to gradually learn knowledge related to different types of visual tasks, from easy to difficult, thereby making it possible to share training data across different visual tasks and improve the processing performance of visual tasks.

According to an example implementation of the present disclosure, the first stage of training can be performed based on the object detection dataset, so that the generic processing model describes the association relationship between the image data in the object detection dataset and the bounding boxes of objects in the image data. In the first stage, UNINEXT can be preprocessed on the large-scale object detection dataset (e.g., Objects365) to learn generic knowledge about objects. Since Objects365 does not have mask annotations, two auxiliary losses based on the BoxInst technical solution can be introduced to train the mask branch. At this time, the loss function in the first stage can be formulated as:

$${ℒ}_{stage 1} = {ℒ}_{retrieve} + {ℒ}_{box} + {ℒ}_{mask}^{boxinst} \qquad Formula 4$$

In Formula 4, [symbol] _{stage1} represents the loss function in the first stage. [symbol] ᵣₑₜᵣᵢₑᵥₑ represents the loss function associated with object recognition in the object detection dataset, [symbol] _{box} represents the loss function associated with the bounding box of the object, and [symbol] ₘₐₛₖ^{boxinst} represents the mask-related loss function determined based on the BoxInst mask technical solution. With the example implementation of the present disclosure, annotation data in the object detection dataset can be fully exploited to improve the performance of the generic processing model in performing basic object detection related tasks and improve the generic perception power of the model.

According to an example implementation of the present disclosure, after the first stage of training, the second stage of training can be performed based on the mixed object detection dataset. In this way, it is possible for the generic processing model to describe the association between the image data in the mixed object detection dataset, the bounding boxes of objects in the image data, and the masks of objects. In the second stage, training can be performed on the basis of the model parameters obtained in the first stage. Specifically, UNINEXT can be jointly fine-tuned on an information-richer image dataset (e.g., a mixed dataset of COCO and RefCOCO, RefCOCO+, and RefCOOg).

At this point, with manually labeled mask annotations, for example, existing loss functions (such as Dice Loss and Focal Loss) can be used to determine the mask from the original video. In addition, in order to avoid the model forgetting the previously learned knowledge on image-level tasks, the image-level dataset can also be transformed into pseudo videos for joint training with other video datasets. The loss function in the second stage can be formulated as:

$${ℒ}_{stage 2} = {ℒ}_{retrieve} + {ℒ}_{box} + {ℒ}_{mask} \qquad Formula 5$$

In Formula 5, [symbol] _{stage2} represents the loss function in the second stage. [symbol] ᵣₑₜᵣᵢₑᵥₑ represents the loss function associated with object recognition in mixed the object detection dataset. [symbol] _{box} represents the loss function associated with the bounding box of the object, and [symbol] ₘₐₛₖ represents the loss function associated with the mask of the object.

According to an example implementation of the present disclosure, after the second stage of training, the third stage of training is performed based on the video dataset. In this way, it is possible for the generic processing model to describe the association between image data in the video dataset, bounding boxes of objects in the image data, and masks of objects. In other words, the generic processing model can obtain video processing-related knowledge with the help of richer training data in the video dataset. The training data in the third stage includes pseudo videos generated from COCO, RefCOCO/g/+, SOT & VOS datasets (GOT-10K, LaSOT, TrackingNet, etc.), MOT & VIS datasets (BDD100K, VIS19, OVIS), and R-VOS datasets. The loss function in the third stage can be formulated as:

$${ℒ}_{stage 3} = {ℒ}_{retrieve} + {ℒ}_{box} + {ℒ}_{mask} \qquad Formula 6$$

In Formula 6, [symbol] _{stage3} represents the loss function in the third stage. [symbol] ᵣₑₜᵣᵢₑᵥₑ represents the loss function associated with the object recognition in the video dataset, [symbol] _{box} represents the loss function associated with the bounding box of the object, and [symbol] ₘₐₛₖ represents the loss function associated with the mask of the object.

According to an example implementation of the present disclosure, in order to further learn the relevant knowledge of performing object tracking between the plurality of video frames in the video, the generic processing model can be trained based on contrastive learning techniques. Specifically, in the third stage, the generic processing model can be made to pull closer the distance between the generic visual representations of two image data including the same object in the video based on comparative learning techniques, and to push farther the distance between the generic visual representations of two image data including different objects in the video, based on contrastive learning techniques. At this time, positive sample pairs can be constructed using video frames including the same object, and negative sample pairs can be constructed using video frames including the same object, so that the generic processing model can learn knowledge about object tracking. During this period, a reference visual encoder for SOT & VOS and an extra contrast module for the association can be introduced and optimized. At this time, the loss function in the third stage can be formulated as follows:

$${ℒ}_{stage 3} = {ℒ}_{retrieve} + {ℒ}_{box} + {ℒ}_{mask} + {ℒ}_{embed} \qquad Formula 7$$

In Formula 7, [symbol] _{embed} represents the correlation loss function of contrast studies. At this time, the distance between the generic visual representations output by the generic processing model for two image frames in the positive sample pair is smaller, and the distance between the generic visual representations output in parallel for two image frames in the negative sample pair is larger. In this way, the performance of the generic processing model can be improved in post-processing of video-related visual tasks.

Where the generic processing model has been obtained, different types of visual tasks can be performed with the model. Here, the visual tasks can include but not limited to: object detection, instance segmentation, multi-object tracking, multi-object tracking and segmentation, video instance segmentation, referring expression comprehension, referring expression segmentation, referring video object segmentation, single object tracking, and video object segmentation. As shown in FIG. 4, these tasks can be divided into different task subsets. For example, a task subset 460 can involve object detection-related tasks, a task subset 462 can involve referring-related tasks, and task subset 464 can involve video-related tasks.

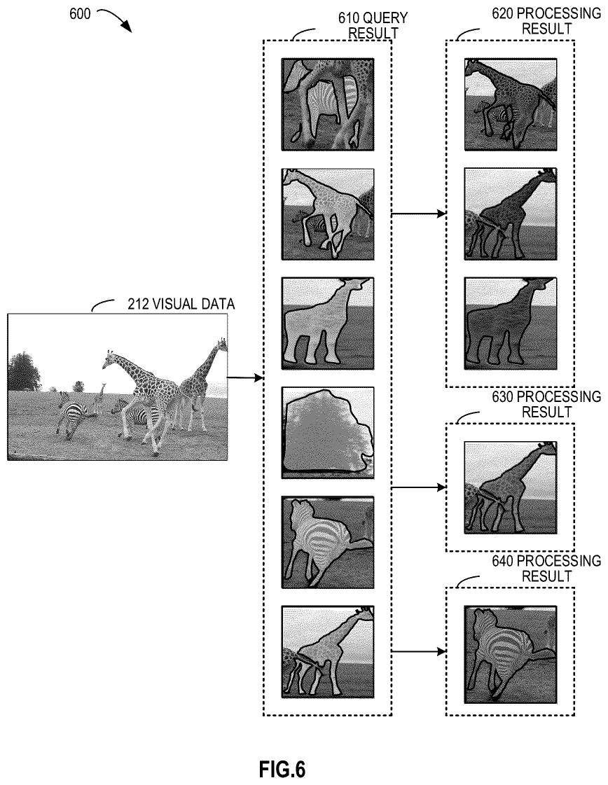

In the inference stage, for tasks that take categories as the prompts, UNINEXT can predict instances of different categories and associate them with previous trajectories. The association proceeds in an online fashion and is implemented based on the learned instance embedding. For tasks that take expressions and annotations as the prompts, the object instance with the highest matching score for a given prompt can be directly selected as the final result. Refer to FIG. 6 for more details of performing visual tasks, which shows a block diagram 600 of the process of performing a plurality of visual tasks according to some implementations of the present disclosure.

As shown in FIG. 6, a plurality of query results 610 can be obtained from the visual data 212. At this time, different processing results will be output for different prompt data. For example, suppose the prompt data is the prompt 310 (“person, . . . , giraffe, . . . , zebra”) as shown in FIG. 3. At this time, the prompt belongs to the type represented by the category name, and the generic processing model can output a processing result 620, that is, the processing result 620 includes the mask of the area where the giraffe recognized from the visual data 212 is located.

For example, suppose the prompt data is the prompt 320 (“giraffe on the right”) as shown in FIG. 3. At this time, the prompt belongs to the type directly represented by the language expression, and the generic processing model can output a processing result 630, that is, the processing result 630 includes the mask of the area where the giraffe on the right recognized from the visual data 212 is located.

As another example, suppose that the prompt data is the prompt 330 as shown in FIG. 3. At this time, the prompt belongs to the image type represented by annotations (that is, it is desirable to recognize “zebras” from the visual data 212). At this time, the generic processing model can output a processing result 630, that is, the processing result 630 includes the mask of the area where the zebra recognized from the visual data 212 is located.

It will be appreciated that, although FIG. 6 only uses object detection as a specific example of the visual task 230, the processing results of recognizing objects specified by the prompt data from the visual data 212 using a generic purpose processor are described. Alternatively and/or additionally, the generic processing model may be utilized to perform other tasks. According to one example implementation of the present disclosure, the instance representation model described above may be implemented on different backbone networks. For example, ResNet-50 and ConvNeXt Large may be used as visual encoders. The BERT model may be employed as the prompt encoder, and the parameters of the encoder may be trained in the first stage and the second stage. Existing transformer encoder-decoder architectures may be utilized, for example, 6 encoder layers and 6 decoder layers may be used. The number of queries N of the object queryer may be set to 300. The AdamW Optimizer may be used with the weight decay of 0.05.

According to an example implementation of the present disclosure, existing instance perception tasks are divided into three categories. (1) Object detection, instance segmentation, MOT, MOTS, and VIS take category names as prompts to find instances of specific categories. (2) REC, RES, and R-VOS take text expressions as prompts to locate specific instances. (3) SOT and VOS take reference annotations as prompts, for example, using the reference annotation given in the first frame as the prompt to track instances associated with the reference annotation in videos. All of the above tasks aim to find instances of objects specified by some prompts. Based on the above commonality, all instance perception tasks can be reformulated into a generic object discovery and retrieval problem and expressed through a unified model architecture and learning paradigm.

Different visual tasks can be processed using the model configured as described above. Specifically, Tables 1 to 4 below show the test results for performing different tasks using a generic instance representation. Table 1 shows the performance comparison of object detection tasks based on multiple technical solutions. As shown in Table 1, the first column shows the models used by multiple technical solutions as the basis for comparison, the second column shows the structure of the backbone network used by each model, and the third column shows the average accuracy of each technical solution. As shown in bold in Table 1, when using the UNINEXT technical solution according to the present disclosure, higher average accuracy can be achieved.

TABLE 1
Performance Comparison of Object Detection Tasks

| Model | Backbone | AP | AP₅₀ | AP₇₅ | AP_{S} | AP_{M} | AP_{L} |
|---|---|---|---|---|---|---|---|
| Faster R-CNN | ResNet-50 | 42.0 | 62.1 | 45.5 | 26.6 | 45.4 | 53.4 |
| Conditional-DETR | | 43.0 | 64.0 | 45.7 | 22.7 | 46.7 | 61.5 |
| DETR | | 43.3 | 63.1 | 45.9 | 22.5 | 47.3 | 63.1 |
| Sparse R-CNN | | 45.0 | 63.4 | 48.2 | 26.9 | 47.2 | 59.5 |
| Cascade Mask-RCNN | | 46.3 | 64.3 | 50.5 | — | — | — |
| Deformable-DETR | | 46.9 | 65.6 | 51.0 | 29.6 | 50.1 | 61.6 |
| AdaMixer | | 47.0 | 66.0 | 51.1 | 30.1 | 50.2 | 61.8 |
| UNINEXT | | 47.8 | 64.2 | 52.3 | 29.4 | 52.1 | 63.0 |
| Cascade Mask R-CNN | ConvNeXt-L | 54.8 | 73.8 | 59.8 | — | — | — |
| UNINEXT | | 55.6 | 72.5 | 60.6 | 37.7 | 60.3 | 72.7 |

Table 2 shows the performance comparison of referring expression comprehension tasks based on multiple technical solutions. As shown in bold in Table 2, when using the UNINEXT technical solution according to the present disclosure, higher average accuracy can be achieved.

TABLE 2
Performance Comparison of Referring Expression Comprehension Tasks

| Model | Backbone | AP | AP₅₀ | AP₇₅ | AP_{S} | AP_{M} | AP_{L} |
|---|---|---|---|---|---|---|---|
| Mask R-CNN | ResNet-50 | 37.5 | 59.3 | 40.2 | 21.1 | 39.6 | 48.3 |
| CondInst | | 38.6 | 60.2 | 41.4 | 20.6 | 41.0 | 51.1 |
| Cascade Mask R-CNN | | 38.6 | 60.0 | 41.7 | 21.7 | 40.8 | 49.6 |
| SOLOv2 | | 38.8 | 59.9 | 41.7 | 16.5 | 41.7 | 56.2 |
| HTC | | 39.7 | 61.4 | 43.1 | 22.6 | 42.2 | 50.6 |
| RefineMask | | 40.2 | — | — | — | — | — |
| QueryInst | | 40.6 | 63.0 | 44.0 | 23.4 | 42.5 | 52.8 |
| UNINEXT | | 42.6 | 63.5 | 46.5 | 23.5 | 46.3 | 56.9 |
| Cascade Mask R-CNN | Swin-L | 46.7 | 70.1 | 50.8 | — | — | — |
| QueryInst | | 49.1 | 74.2 | 53.8 | 31.5 | 51.8 | 63.2 |
| Cascade Mask R-CNN | ConvNeXt-L | 47.6 | 71.3 | 51.7 | — | — | — |
| UNINEXT | | 48.1 | 70.9 | 52.5 | 28.2 | 52.0 | 64.8 |

Table 3 shows the performance comparison of referring expression segmentation tasks based on multiple technical solutions. The first column on the left side of Table 3 shows multiple methods, and the right side shows multiple performance indicators used to measure task execution performance. As shown in bold in Table 3, when using the UNINEXT technical solution according to the present disclosure, each performance indicator is the optimal value.

TABLE 3
Comparison of Performance of Reference Expression Segmentation Tasks

| | RefCOCO | | | RefCOCO+ | | | RefCOCOg | |
|---|---|---|---|---|---|---|---|---|
| Method | val | testA | testB | val | testA | testB | val-u | test-u |
| UNITER_{L} | 81.41 | 87.04 | 74.17 | 75.90 | 81.45 | 66.70 | 74.86 | 75.77 |
| VILLA_{L} | 82.39 | 87.48 | 74.84 | 76.17 | 81.54 | 66.84 | 76.18 | 76.71 |
| MDETR | 86.75 | 89.58 | 81.41 | 79.52 | 84.09 | 70.62 | 81.64 | 80.89 |
| RefTR | 85.65 | 88.73 | 81.16 | 77.55 | 82.26 | 68.99 | 79.25 | 80.01 |
| SeqTR | 87.00 | 90.15 | 83.59 | 78.69 | 84.51 | 71.87 | 82.69 | 83.37 |
| UNINEXT-R50 | 89.29 | 91.67 | 86.97 | 79.62 | 85.16 | 72.10 | 83.37 | 84.11 |
| UNINEXT-L | 91.26 | 93.39 | 88.44 | 83.39 | 88.88 | 76.97 | 87.28 | 87.95 |

As seen from the experimental data in Tables 1 to 3, with the proposed UNINEXT technical solution, the object discovery and retrieval paradigms related to a plurality of visual tasks can be unified. Extensive experiments demonstrate that compared with multiple existing technical solutions, UNINEXT can achieve better results in performing a large number of challenging visual tasks.

With the example implementation of the present disclosure, UNINEXT can learn strong generic representations on massive data from various tasks and perform individual instance perception tasks using a single model with the same model parameters. Extensive experiments have shown that UNINEXT has achieved excellent results on a large amount of test data. In this way, UNINEXT can reunite fragmented instance perception tasks into a whole, and then perform joint training on different tasks and domains without the need to develop models separately for each specific task. Furthermore, UNINEXT can use a unified model with the same model parameters and achieve superior performance on multiple instance perception tasks.

### Example Process

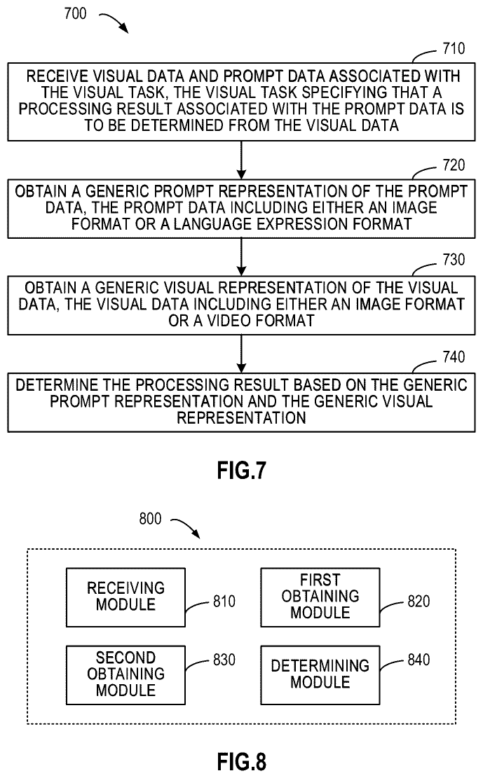

FIG. 7 shows a flowchart of a method 700 of processing a visual task by a generic processing model according to some implementations of the present disclosure. At a block 710, visual data and prompt data associated with the visual task are received, the visual task specifying that a processing result associated with the prompt data is to be determined from the visual data. At a block 720, a generic prompt representation of the prompt data is obtained, the prompt data including either an image format or a language expression format. At a block 730, a generic visual representation of the visual data is obtained, the visual data including either an image format or a video format. At a block 740, the processing result is determined based on the generic prompt representation and the generic visual representation.

According to an example implementation of the present disclosure, obtaining the generic prompt representation comprises: extracting the generic prompt representation based on a format of the prompt data.

According to an example implementation of the present disclosure, extracting the generic prompt representation comprises at least one of: in response to determining that the format of the prompt data is a language expression format, extracting the prompt representation using a language expression encoder: in response to determining that the format of the prompt data is an image format, extracting the generic prompt representation based on an extended image including an annotation image specified by the prompt data.

According to an example implementation of the present disclosure, extracting the generic prompt representation based on the extended image comprises: determining a first representation associated with the prompt data based on a plurality of pixel data in the extended image: determining a second representation associated with the prompt data based on prior values of the plurality of pixel data in the extended image, the prior value of the pixel data in the plurality of pixel data indicating whether the pixel data belongs to the annotation image: and combining the first representation and the second representation to form the generic prompt representation.

According to an example implementation of the present disclosure, determining the processing result comprises: performing an attention operation on the generic prompt representation and the generic visual representation to update the generic prompt representation and the generic visual representation, respectively: and obtaining the processing result using the updated generic prompt representation and the updated generic visual representation.

According to an example implementation of the present disclosure, updating the generic prompt representation comprises: performing an attention operation in a first direction on the generic prompt representation and the generic visual representation to determine a first attention representation between the generic prompt representation and the generic visual representation: and updating the generic prompt representation with the first attention representation.

According to an example implementation of the present disclosure, updating the generic visual representation comprises: performing an attention operation in a second direction on the generic prompt representation and the generic visual representation to determine a second attention representation between the generic prompt representation and the generic visual representation: and updating the generic visual representation with the second attention representation.

According to an example implementation of the present disclosure, obtaining the processing result comprises: querying a plurality of candidate query results corresponding to the prompt data in the image data based on the updated generic prompt representation and the updated generic visual representation: determining scores of the plurality of candidate query results respectively based on the plurality of candidate query results and a weight associated with the prompt data: and determining the processing result based on the scores of the plurality of candidate query results.

According to an example implementation of the present disclosure, the method further comprises at least any of: in response to determining that the prompt data is a category name defined according to the language expression format, determining the weight based on the updated generic prompt representation: in response to determining that the prompt data is either of a description defined according to the language expression format or the image format, determining the weight based on global average pooling of the updated prompt representation.

According to an example implementation of the present disclosure, the method further comprises performing multi-stage training on the generic processing model, the multi-stage training comprising: performing first-stage training based on an object detection dataset such that the generic processing model describes an association between image data in the object detection dataset and a bounding box of an object in the image data.

According to an example implementation of the present disclosure, the method further comprises: after the first-stage training, performing a second-stage training based on a mixed object detection dataset such that the generic processing model describes an association between image data in the mixed object detection dataset, a bounding box of an object in the image data, and a mask of the object.

According to an example implementation of the present disclosure, the method further comprises: after the second-stage training, performing third-stage training based on a video dataset such that the generic processing model describes an association between image data in a video in the video data set, a bounding box of an object in the image data, and a mask of the object.

According to an example implementation of the present disclosure, the method further comprises: performing third-stage training based on the video dataset such that the generic processing model pulls closer a distance between generic visual representations of two image data in the video including the same object and pushes farther a distance between generic visual representations of two image data in the video including different objects.

According to an example implementation of the present disclosure, the visual task comprises at least any of: object detection, instance segmentation, multi-object tracking, multi-object tracking and segmentation, video instance segmentation, referring expression comprehension, referring expression segmentation, referring video object segmentation, single object tracking, video object segmentation.

### Example Apparatus and Equipment

FIG. 8 shows a block diagram of an apparatus 800 for processing a visual task by a generic processing model according to some implementations of the present disclosure. The apparatus comprises: a receiving module 810, configured for receiving visual data and prompt data associated with the visual task, the visual task specifying that a processing result associated with the prompt data is to be determined from the visual data: a first obtaining module 820, configured for obtaining a generic prompt representation of the prompt data, the prompt data including either an image format or a language expression format: a second obtaining module 830, configured for obtaining a generic visual representation of the visual data, the visual data including either an image format or a video format: and a determination module 840, configured for determining the processing result based on the generic prompt representation and the generic visual representation.

According to an example implementation of the present disclosure, the first obtaining module comprises: an extracting module, configured for extracting the generic prompt representation based on a format of the prompt data.

According to an example implementation of the present disclosure, the extracting module comprises at least one of: a first extracting module, configured for in response to determining that the format of the prompt data is a language expression format, extracting the prompt representation using a language expression encoder: a second extracting module, configured for in response to determining that the format of the prompt data is an image format, extracting the generic prompt representation based on an extended image including an annotation image specified by the prompt data.

According to an example implementation of the present disclosure, the second extracting module comprises: a first representation determining module, configured for determining a first representation associated with the prompt data based on a plurality of pixel data in the extended image: a second representation determining module, configured for determining a second representation associated with the prompt data based on prior values of the plurality of pixel data in the extended image, the prior value of the pixel data in the plurality of pixel data indicating whether the pixel data belongs to the annotation image: and a combining module, configured for combining the first representation and the second representation to form the generic prompt representation.

According to an example implementation of the present disclosure, the determining module comprises: an updating module, configured for performing an attention operation on the generic prompt representation and the generic visual representation to update the generic prompt representation and the generic visual representation, respectively: and a result obtaining module, configured for obtaining the processing result using the updated generic prompt representation and the updated generic visual representation.

According to an example implementation of the present disclosure, the updating module comprises: a first attention module, configured for performing an attention operation in a first direction on the generic prompt representation and the generic visual representation to determine a first attention representation between the generic prompt representation and the generic visual representation: and a first updating module, configured for updating the generic prompt representation with the first attention representation.

According to an example implementation of the present disclosure, the updating module comprises: a second attention module, configured for performing an attention operation in a second direction on the generic prompt representation and the generic visual representation to determine a second attention representation between the generic prompt representation and the generic visual representation: and a second updating module, configured for updating the generic visual representation with the second attention representation.

According to an example implementation of the present disclosure, the result obtaining module comprises: a querying module, configured for querying a plurality of candidate query results corresponding to the prompt data in the image data based on the updated generic prompt representation and the updated generic visual representation: a score determining module, configured for determining scores of the plurality of candidate query results respectively based on the plurality of candidate query results and a weight associated with the prompt data: and a processing result determining module, configured for determining the processing result based on the scores of the plurality of candidate query results.

According to an example implementation of the present disclosure, the apparatus further comprises: a first weight determining module, configured for in response to determining that the prompt data is a category name defined according to the language expression format, determining the weight based on the updated generic prompt representation: a second weight determining module, configured for in response to determining that the prompt data is either of a description defined according to the language expression format or the image format, determining the weight based on global average pooling of the updated prompt representation.

According to an example implementation of the present disclosure, the apparatus further comprises: a training module, configured for performing multi-stage training on the generic processing model, the training comprises: a first training module, configured for performing first-stage training based on an object detection dataset such that the generic processing model describes an association between image data in the object detection dataset and a bounding box of an object in the image data.

According to an example implementation of the present disclosure, the training module further comprises: a second training module, configured for, after the first-stage training, performing a second-stage training based on a mixed object detection dataset such that the generic processing model describes an association between image data in the mixed object detection dataset, a bounding box of an object in the image data, and a mask of the object.

According to an example implementation of the present disclosure, the training module further comprises: a third training module, configured for, after the second-stage training, performing third-stage training based on a video dataset such that the generic processing model describes an association between image data in a video in the video data set, a bounding box of an object in the image data, and a mask of the object.

According to an example implementation of the present disclosure, the third training module further comprises: a contrastive learning module, configured for performing third-stage training based on the video dataset such that the generic processing model pulls closer a distance between generic visual representations of two image data in the video including the same object and pushes farther a distance between generic visual representations of two image data in the video including different objects.

According to an example implementation of the present disclosure, the visual task comprises at least any of: object detection, instance segmentation, multi-object tracking, multi-object tracking and segmentation, video instance segmentation, referring expression comprehension, referring expression segmentation, referring video object segmentation, single object tracking, video object segmentation.

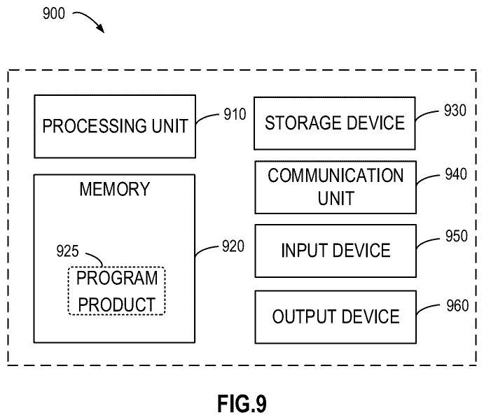

FIG. 9 shows a block diagram of a device 900 that can implement a plurality of implementations of the present disclosure. It would be understood that the electronic device 900 shown in FIG. 9 is only an example and should not constitute any restriction on the function and scope of the implementations described herein.

As shown in FIG. 9, the electronic device 900 is in the form of a general computing device. The components of the electronic device 900 may comprise but are not limited to, one or more processors or processing units 910, a memory 920, a storage device 930, one or more communication units 940, one or more input devices 950, and one or more output devices 960. The processing unit 910 may be an actual or virtual processor and can execute various processes according to the programs stored in the memory 920. In a multiprocessor system, a plurality of processing units execute computer executable instructions in parallel to improve the parallel processing capability of the electronic device 900.

The electronic device 900 typically comprises a variety of computer storage medium. Such medium may be any available medium that is accessible to the electronic device 900, comprising but not limited to volatile and non-volatile medium, removable, and non-removable medium. The memory 920 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 930 may be any removable or non-removable medium and may comprise a machine-readable medium, such as a flash drive, a disk, or any other medium, which can be used to store information and/or data (such as training data for training) and can be accessed within the electronic device 900.

The electronic device 900 may further comprise additional removable/non-removable, volatile/non-volatile storage medium. Although not shown in FIG. 9, a disk driver for reading from or writing to a removable, non-volatile disk (such as a “floppy disk”), and an optical disk driver for reading from or writing to a removable, non-volatile optical disk can be provided. In these cases, respective driver may be connected to the bus (not shown) by one or more data medium interfaces. The memory 920 may comprise a computer program product 925, which has one or more program modules configured to perform various methods or acts of various implementations of the present disclosure.

The communication unit 940 communicates with a further computing device through the communication medium. In addition, functions of components in the electronic device 900 may be implemented by a single computing cluster or a plurality of computing machines, which can communicate through a communication connection. Therefore, the electronic device 900 may be operated in a networking environment with a logical connection with one or more other servers, a network personal computer (PC), or another network node.

The input device 950 may be one or more input devices, such as a mouse, a keyboard, a trackball, etc. The output device 960 may be one or more output devices, such as a display, a speaker, a printer, etc. The electronic device 900 may also communicate with one or more external devices (not shown) through the communication unit 940 as required. The external device, such as a storage device, a display device, etc., communicates with one or more devices that enable users to interact with the electronic device 900, or communicate with any device (for example, a network card, a modem, etc.) that makes the electronic device 900 communicate with one or more other computing devices. Such communication may be executed via an input/output (I/O) interface (not shown).

According to the example implementation of the present disclosure, a computer-readable storage medium is provided, on which a computer-executable instruction or computer program is stored, wherein the computer-executable instructions or the computer program is executed by the processor to implement the method described above. According to the example implementation of the present disclosure, a computer program product is also provided. The computer program product is physically stored on a non-transient computer-readable medium and comprises computer-executable instructions, which are executed by the processor to implement the method described above. According to the example implementation of the present disclosure, a computer program product is provided, on which computer program is stored and the program implements the method described above when executed by a processor.

Various aspects of the present disclosure are described herein with reference to the flow chart and/or the block diagram of the method, the device, the equipment, and the computer program product implemented according to the present disclosure. It would be understood that respective block of the flowchart and/or the block diagram and the combination of respective blocks in the flowchart and/or the block diagram may be implemented by computer-readable program instructions.

These computer-readable program instructions may be provided to the processing units of general-purpose computers, special computers, or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device, and/or other devices to work in a specific way. Therefore, the computer-readable medium containing the instructions comprises a product, which comprises instructions to implement various aspects of the functions/acts specified in one or more blocks in the flowchart and/or the block diagram.

The computer-readable program instructions may be loaded onto a computer, other programmable data processing apparatus, or other devices, so that a segment of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions, and operations of the system, the method, and the computer program product implemented according to the present disclosure. In this regard, respective block in the flowchart or the block diagram may represent a part of a module, a program segment, or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that respective block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Respective implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application, or improvement of technology in the market of respective implementation, or to enable other ordinary skills in the art to understand the various implementations disclosed herein.

1. A method of processing a visual task by a generic processing model, comprising:
receiving visual data and prompt data associated with the visual task, the visual task specifying that a processing result associated with the prompt data is to be determined from the visual data;
obtaining a generic prompt representation of the prompt data, the prompt data including either an image format or a language expression format;
obtaining a generic visual representation of the visual data, the visual data including either an image format or a video format; and
determining the processing result based on the generic prompt representation and the generic visual representation.

2. The method of claim 1, wherein obtaining the generic prompt representation comprises: extracting the generic prompt representation based on a format of the prompt data.

3. The method of claim 2, wherein extracting the generic prompt representation comprises at least one of:
in response to determining that the format of the prompt data is a language expression format, extracting the prompt representation using a language expression encoder;
in response to determining that the format of the prompt data is an image format, extracting the generic prompt representation based on an extended image including an annotation image specified by the prompt data.

4. The method of claim 3, wherein extracting the generic prompt representation based on the extended image comprises:
determining a first representation associated with the prompt data based on a plurality of pixel data in the extended image;
determining a second representation associated with the prompt data based on prior values of the plurality of pixel data in the extended image, the prior value of the pixel data in the plurality of pixel data indicating whether the pixel data belongs to the annotation image; and
combining the first representation and the second representation to form the generic prompt representation.

5. The method of claim 1, wherein determining the processing result comprises:
performing an attention operation on the generic prompt representation and the generic visual representation to update the generic prompt representation and the generic visual representation, respectively; and
obtaining the processing result using the updated generic prompt representation and the updated generic visual representation.

6. The method of claim 5, wherein updating the generic prompt representation comprises:
performing an attention operation in a first direction on the generic prompt representation and the generic visual representation to determine a first attention representation between the generic prompt representation and the generic visual representation; and
updating the generic prompt representation with the first attention representation.

7. The method of claim 5, wherein updating the generic visual representation comprises:
performing an attention operation in a second direction on the generic prompt representation and the generic visual representation to determine a second attention representation between the generic prompt representation and the generic visual representation; and
updating the generic visual representation with the second attention representation.

8. The method of claim 5, wherein obtaining the processing result comprises:
querying a plurality of candidate query results corresponding to the prompt data in the image data based on the updated generic prompt representation and the updated generic visual representation;
determining scores of the plurality of candidate query results respectively based on the plurality of candidate query results and a weight associated with the prompt data; and
determining the processing result based on the scores of the plurality of candidate query results.

9. The method of claim 8, further comprising at least any of:
in response to determining that the prompt data is a category name defined according to the language expression format, determining the weight based on the updated generic prompt representation;
in response to determining that the prompt data is either of a description defined according to the language expression format or the image format, determining the weight based on global average pooling of the updated prompt representation.

10. The method of claim 5, further comprising performing multi-stage training on the generic processing model, the multi-stage training comprising:
performing first-stage training based on an object detection dataset such that the generic processing model describes an association between image data in the object detection dataset and a bounding box of an object in the image data.

11. The method of claim 10, further comprising: after the first-stage training, performing a second-stage training based on a mixed object detection dataset such that the generic processing model describes an association between image data in the mixed object detection dataset, a bounding box of an object in the image data, and a mask of the object.

12. The method of claim 11, further comprising: after the second-stage training, performing third-stage training based on a video dataset such that the generic processing model describes an association between image data in a video in the video data set, a bounding box of an object in the image data, and a mask of the object.

13. The method of claim 12, further comprising: performing third-stage training based on the video dataset such that the generic processing model pulls closer a distance between generic visual representations of two image data in the video including the same object and pushes farther a distance between generic visual representations of two image data in the video including different objects.

14. The method of claim 1, wherein the visual task comprises at least any of: object detection, instance segmentation, multi-object tracking, multi-object tracking and segmentation, video instance segmentation, referring expression comprehension, referring expression segmentation, referring video object segmentation, single object tracking, video object segmentation.

15-17. (canceled)

18. An electronic device comprising:
at least one processing unit; and
at least one memory, coupled to the at least one processing unit and storing instructions for execution by the at least one processing unit, the instructions, when executed by the at least one processing unit, causing the electronic device to perform a method of processing a visual task by a generic processing model, the method comprising:
receiving visual data and prompt data associated with the visual task, the visual task specifying that a processing result associated with the prompt data is to be determined from the visual data;
obtaining a generic prompt representation of the prompt data, the prompt data including either an image format or a language expression format;
obtaining a generic visual representation of the visual data, the visual data including either an image format or a video format; and
determining the processing result based on the generic prompt representation and the generic visual representation.

19. The device of claim 18, wherein obtaining the generic prompt representation comprises: extracting the generic prompt representation based on a format of the prompt data.

20. The device of claim 19, wherein extracting the generic prompt representation comprises at least one of:
in response to determining that the format of the prompt data is a language expression format, extracting the prompt representation using a language expression encoder;
in response to determining that the format of the prompt data is an image format, extracting the generic prompt representation based on an extended image including an annotation image specified by the prompt data.

21. The device of claim 20, wherein extracting the generic prompt representation based on the extended image comprises:
determining a first representation associated with the prompt data based on a plurality of pixel data in the extended image;
determining a second representation associated with the prompt data based on prior values of the plurality of pixel data in the extended image, the prior value of the pixel data in the plurality of pixel data indicating whether the pixel data belongs to the annotation image; and
combining the first representation and the second representation to form the generic prompt representation.

22. The device of claim 18, wherein determining the processing result comprises:
performing an attention operation on the generic prompt representation and the generic visual representation to update the generic prompt representation and the generic visual representation, respectively; and
obtaining the processing result using the updated generic prompt representation and the updated generic visual representation.

23. A non-transitory computer-readable storage medium, on which a computer program is stored, the computer program, when executed by a processor, causing the processor to perform a method of processing a visual task by a generic processing model, the method comprising:
receiving visual data and prompt data associated with the visual task, the visual task specifying that a processing result associated with the prompt data is to be determined from the visual data;
obtaining a generic prompt representation of the prompt data, the prompt data including either an image format or a language expression format;
obtaining a generic visual representation of the visual data, the visual data including either an image format or a video format; and
determining the processing result based on the generic prompt representation and the generic visual representation.
